(19) United States
(12) Patent Application Publication
(10) Pub. No.: US 2004/0083615 A1
(43) Pub. Date: May 6, 2004

(54) Precise measuring device

(76) Inventor: Terry L. Cotner, Warrenton, MO (US)

Correspondence Address: Henry W. Cummings, 3313 W. Adams St., St. Charles, MO, 63301, US

(21) Appl. No.: 10/287,970

(22) Filed: Nov. 6, 2002

(51) Int. Cl. G01B 5/255

(52) U.S. Cl. 33/288

(57) ABSTRACT

The present invention comprises a modified commercially available laser level, with a series of accessories to enable it to be used in a variety of usage configurations and orientations. The precise lazer tool includes at least one laser level assembly, at least two extensions, at least two base assemblies, at least one free standing magnetic scale, and a magnetic tape measure. The present invention is capable of establishing a datum line under the vehicle or other structure, along the sides, or other points remote from the frame. In addition, the present invention has means for placing it on a level surface. The present invention is also significantly less expensive than prior measuring devices.

### I FIELD OF THE INVENTION

This invention relates to an improved measuring device.

### II BACKGROUND OF THE INVENTION

In the event a vehicle is involved in an accident to the extent that its frame is damaged or deformed, it must be straightened prior to the performance of any body work. In a traditional repair shop, a device known as a ladder or rack system is employed to straighten a frame. This system is very expensive and requires time consuming setup prior to beginning work. Specific reference points need to be preset per the manufacturer's specifications before the damaged vehicle or structure is placed on the rack. Frame members which do not correspond to the rack's presets must then be forced back into shape. Alternatively, damaged frame members may be compared with undamaged members to determine the extent of damage. To this end, accurate measurements must be taken from undamaged portions of the frame and compared with the corresponding damaged areas.

U.S. Pat. No. 6,105,264 discloses an automobile frame dimensioning tool. This device uses a magnetic element which needs to be affixed to a specific point on a vehicle frame. A laser assembly is moved into a position to set up a datum line under the vehicle, said datum line is established by the laser beam. Measurements are then taken from various points on the frame to the laser beam. If the measurements do not agree with the manufacturer's specifications, the frame must be straightened at those points. This invention is limited to creating a datum line directly under the structure's frame, and it must be affixed to the frame by magnetic or other means.

### III. SUMMARY OF THE INVENTION

A. Objects of the Invention

One object of the present invention is to provide a means to measure the extent of structure frame damage.

Another object of the present invention is to provide a means to accurately straighten structure and vehicle frames without the need to purchase large, cumbersome, and expensive shop equipment such as a rack or ladder system.

Another object of the present invention is to decrease the time required to determine frame damage.

Another object of the present invention is to make the device inexpensive.

Other objects will be apparent from the following Descriptions and Drawings.

B. Summary

The present invention comprises a modified commercially available laser level, with a series of accessories to enable it to be used in a variety of usage configurations and orientations. The precise lazer tool includes at least one laser level assembly, at least two extensions, at least two base assemblies, at least one free standing magnetic scale, and a magnetic tape measure. The present invention is capable of establishing a datum line under the vehicle or other structure, along the sides, or other points remote from the frame. In addition, the present invention has means for placing it on a level surface. The present invention is also significantly less expensive than prior measuring devices.

### IV. THE DRAWINGS

FIG. 1 is a perspective view of the laser level assembly of the present invention.

FIG. 1A is a perspective view of the base of the present invention.

FIG. 1B is a perspective view of the long extension of the present invention.

FIG. 1C is a perspective view of the small extension of the present invention.

FIG. 1D is a perspective view of the tape meassure of the present invention.

FIG. 1E is a perspective view of the stand assembly of the present invention.

FIG. 2 is a detail perspective view of the laser level assembly of the present invention showing all its component parts.

FIG. 3A is a perspective view of one possible usage configuration of the present invention.

FIG. 3B is a perspective view of another possible usage configuration of the present invention.

FIG. 4A is a top view of the present invention showing one of the spirit levels used for leveling.

FIG. 4A is a side view of the present invention showing one of the spirit levels used for leveling.

FIG. 4C is a perspective view of the present invention showing how the laser beam is adjusted.

FIG. 5 is a top view of a damaged vehicle showing one usage of the present invention.

FIG. 6 is a side view of a damaged vehicle showing another usage of the present invention.

### V. DESCRIPTION OF PREFERRED EMBODIMENTS

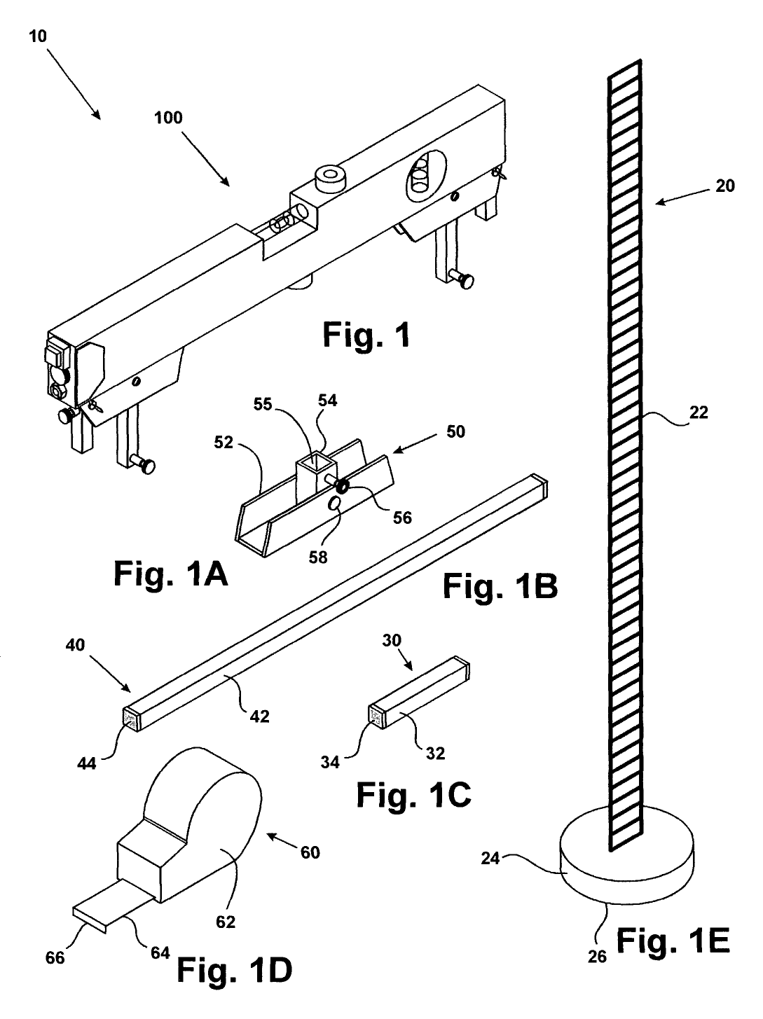

In accordance with the present invention, FIGS. 1 through 1E show perspective views of the complete invention, generally at 10. The six major sections of the present invention are free standing scale 20, small extension 30, for example of 3″, a second longer extension 40 of for example 15″, a stand assembly 50, tape measure 60, and laser level assembly 100.

Free standing scale 20 comprises a ruled surface 22, which may be made of metal, plastic, or other durable material and is marked in inches, centimeters, or any other system of measurement. Ruled surface 22 is affixed to magnetic base 24, which contains magnet 26. Magnet 26 provides weight to allow free standing scale 20 to stand firmly on a horizontal surface, in addition to allowing it to be affixed to any ferrous surface.

Small extension 30 comprises body 32, which is made of metal, plastic, or other durable material and is, for example 2″ to 5″ long, preferably 3″, and plastic end caps 34.

A second longer extension 40 comprises body 42, which is made of metal, plastic, or other durable material, and is, for example 10″ to 20″ long, preferably 15″ and plastic end caps 44.

Base assembly 50 may be made of metal, plastic, or any combination of durable materials. Base assembly 50 comprises foot 52, socket 54, and thumbscrew 56. Socket 54 is pivotably mounted to foot 52 by fastening means 58, which may be a rivet, screw, or nut and bolt. The present invention includes two small extensions 30, at least one large extension 40, and two base assemblies 50.

Tape measure 60 is commercially available and comprises body 62, tape, 64, and magnetic tip 66.

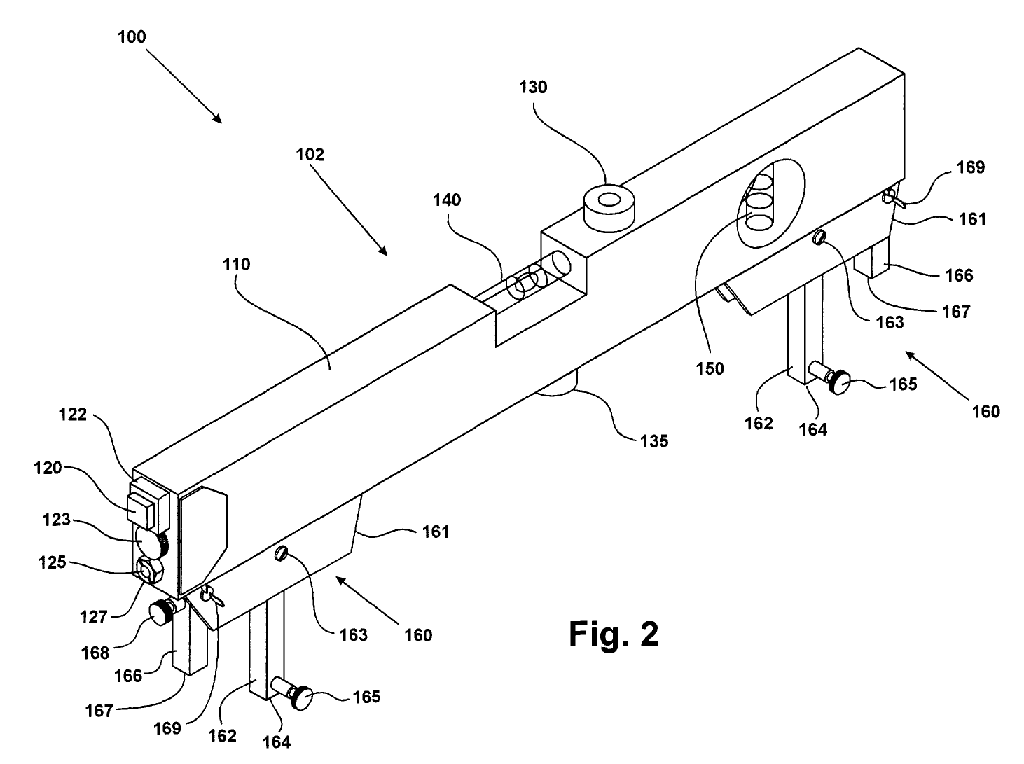

FIG. 2 is a detail view of laser level assembly 100, which is a commercially available unit modified as will be described. The unmodified laser level assembly comprises body 110, on/off switch 120, switch bezel 122, battery cover 123, laser lens 125, adjustment 127, top spirit level 130, bottom spirit level 135, longitudinal spirit level 140, and vertical spirit level 150.

The unmodified laser level 102 is modified by the addition of two mounting assemblies 160 at either end, which may be affixed to the laser level by various means, including but not limited to welding, bonding, rivets, or screws.

Mounting assembly 160 may be made of metal, plastic, or other durable material and comprises frame 161, extension socket 162, and magnetic leg 166. Extension socket is pivotably mounted to frame 161 by mounting means 163. Magnetic leg 166 is removably mounted to frame 161 by wing nut 169.

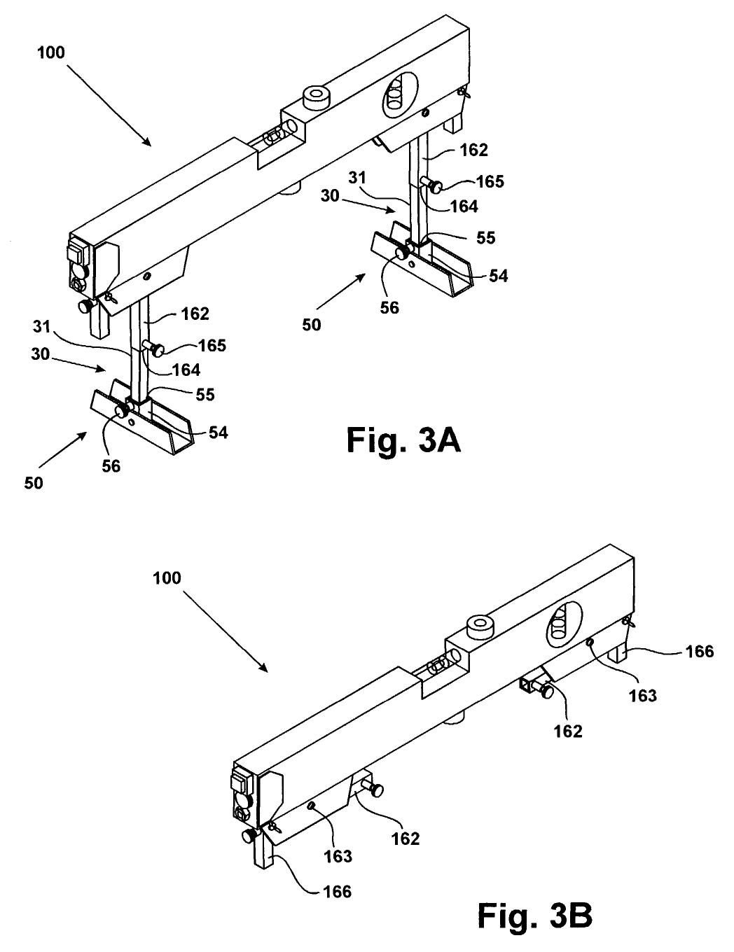

FIG. 3 shows the present invention configured to stand on a surface. Extensions 30 are inserted in openings 55 of sockets 54 of base assemblies 50. Extensions 30 are secured in base assemblies 50 by means of thumbscrews 56. The other ends 31 of extensions 30 are inserted in openings 164 of extension sockets 162 and secured with thumbscrews 165. Note that, if desired, long extensions 40 may be used in place of small extensions 30.

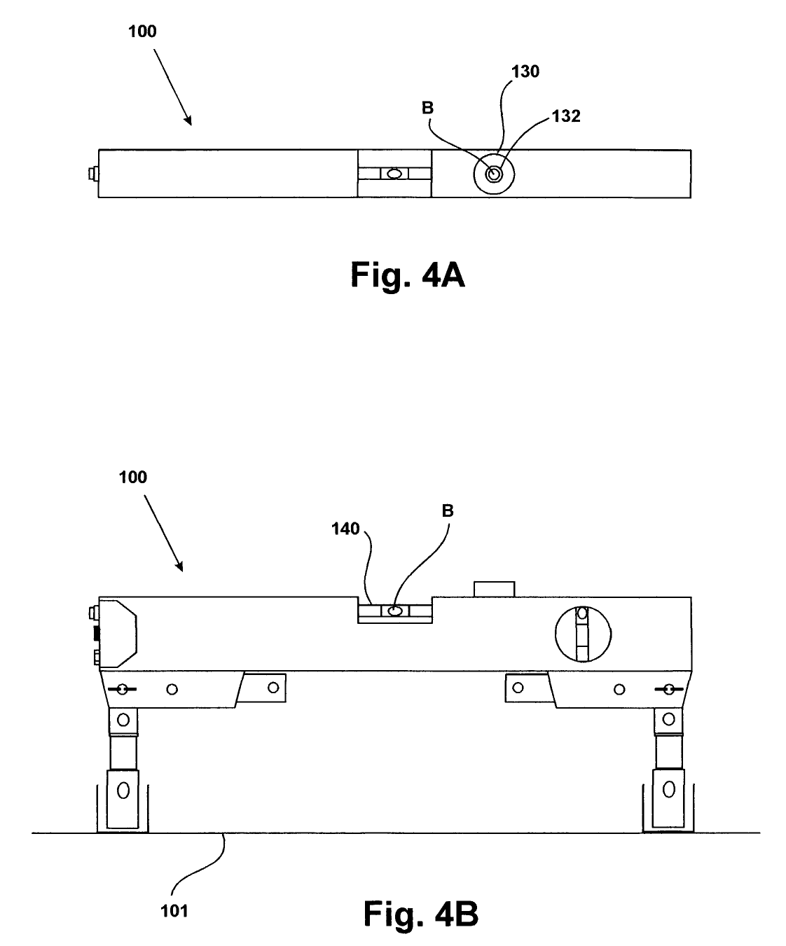

In the configuration shown in FIGS. 4A and 4B, the assembly 100 may be calibrated. This may be done by placing the assembly 100 on a level surface, and adjust the positions of the extensions as required to center bubble B in spirit level 140. Further adjustment of the assembly 100 is made by moving assembly from side-to-side 100 until bubble B is centered in ring 132 of upper spirit level 130.

According to FIG. 4C, turn on the laser light 104 by pressing on/off switch 120, and point laser level assembly 100 toward a convenient vertical surface 108. The laser beam is projected through prism 105 which produces a sharp horizontal line 106. Then ensure this line is exactly level by either measurement or using another level. If the line is not level, the angle 107 of line 106 is adjusted by turning laser adjustment 127.

FIG. 3B shows the present invention configured to be magnetically affixed to a ferrous surface. Extension sockets 162 are pivoted back to lay flat against laser level body 110, allowing magnetic legs 166 to protrude from frames 161. Magnetic legs 166 contain magnets 167, which will permit the present invention to be attached in any orientation to a ferrous surface.

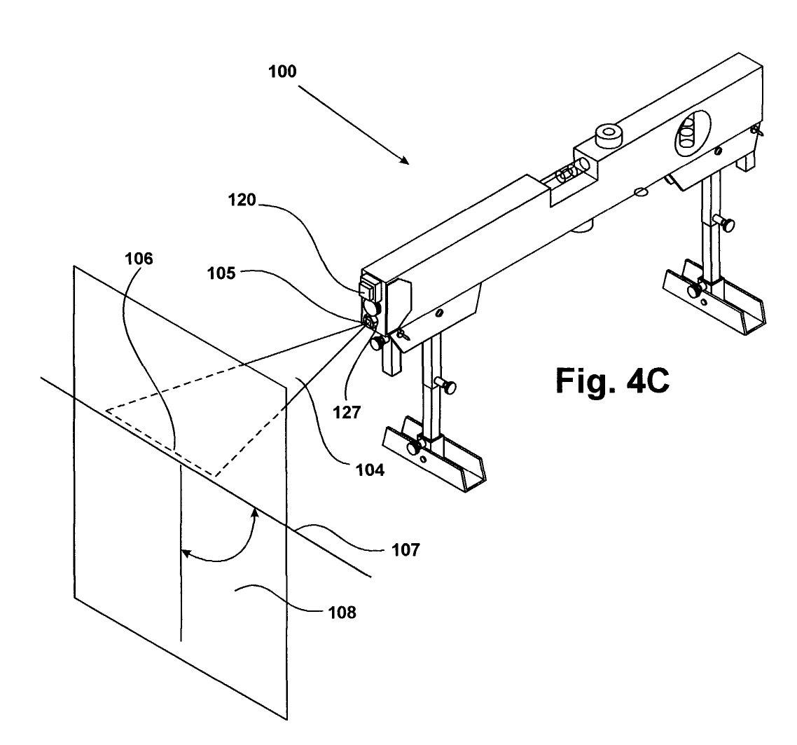

FIG. 5 shows one common use for the present invention. Level assembly 100 is configured as in FIG. 3B, and magnetically affixed to the ferrous side panel of vehicle 200, on its undamaged side 210. To establish an accurate datum line, laser level assembly 100 should be moved around until it is in a level orientation per spirit level 140, as previously described. Laser beam 225 is then projected along that side of vehicle 200.

Measurements may be taken at convenient locations 201, 202, 203, 204, 205, 206, 207 along undamaged side 210. The magnetic tip 66 of tape measure 60 will stay against the side of vehicle 200 allowing tape 64 to be extended from body 62. The point at which laser beam 225 is projected onto tape 64 should be recorded and compared with measurements taken on the damaged side 220 of vehicle 200, using laser beam 230. This comparison will tell the experienced technician where the vehicle's frame is pushed out of position.

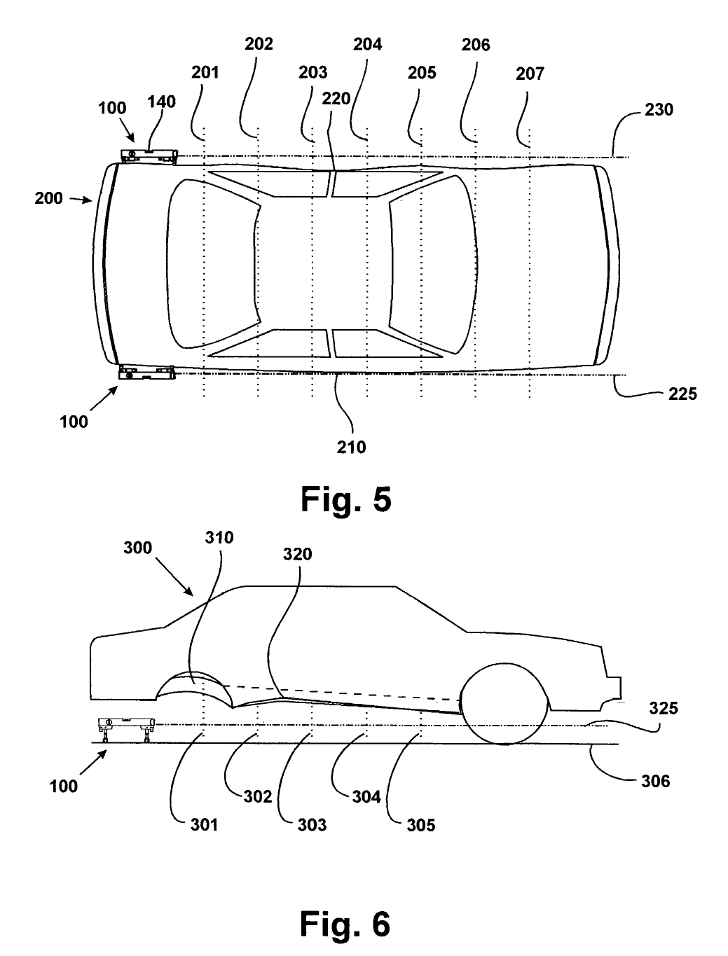

In a like manner, FIG. 6 shows assembly 100 of the present invention configured as in FIG. 3A and standing on a surface 306. It projects laser beam 325, which allows measurements to be taken at convenient points 301, 302, 303, 304, 305 along the damaged frame 320 of vehicle 300. These measurements may be compared with corresponding measurements taken at the same locations on the undamaged side of vehicle 300.

Other configurations and methods of usage will become readily apparent to one skilled in the art.

What is claimed is:

1. A precise lazer tool comprising:
at least one laser level assembly,
at least two extensions,
at least two base assemblies,
at least one free standing magnetic scale, and
a magnetic tape measure.

2. A precise lazer tool comprising a laser level assembly according to claim 1 having means of projecting a laser beam.

3. A precise lazer tool comprising a laser level assembly according to claim 2 having means of calibrating said laser beam.

4. A precise lazer tool comprising a laser level assembly according to claim 1 having means for mounting the assembly on various surfaces in various orientations.

5. A precise lazer tool according to claim 3 wherein said laser beam is projected by means of a prism which causes the beam to project as a straight line.

6. A precise lazer tool according to claim 5 including means for adjusting said prism to cause said laser beam to be turned in any orientation.

7. A precise lazer tool according to claim 3 wherein said calibration means comprise a series of spirit levels.

8. A precise lazer tool according to claim 4 wherein said mounting means comprise mounting assemblies permanently attached to said laser level.

9. A precise lazer tool according to claim 8 wherein said mounting assemblies comprise a pivotable socket which accepts an extension and a magnetic leg.

10. A precise lazer tool according to claim 9 comprising at least two small extensions which fit inside said pivotable sockets.

11. A precise lazer tool according to claim 10 wherein said small extensions which fit inside said pivotable sockets are secured by mechanical fasteners.

12. A precise lazer tool according to claim 1 comprising at least two said large extensions which fit inside said pivotable sockets.

13. A precise lazer tool according to claim 12 wherein said large extensions which fit inside said pivotable sockets are secured by mechanical fasteners.

14. A precise lazer tool according to claim 1 comprising two base assemblies which accept at least one of said extensions and provide a stable support to mount the precise lazer tool on a horizontal surface.

15. A precise lazer tool according to claim 1 comprising at least two magnetic legs which allow the precise laser tool to be mounted in any orientation on a ferrous surface.

16. A precise lazer tool according to claim 1 comprising a free standing magnetic scale wherein a magnet is located in its base allows it to be mounted in any orientation on any ferrous surface.

17. A precise lazer tool according to claim 16 wherein said magnet in its base provides weight which allows it to stand securely on a level surface.

18. A precise lazer tool according to claim 1 comprising a free standing magnetic scale is permanently attached to said base.

19. A precise lazer tool according to claim 18 wherein said free standing magnetic scale is calibrated in a convenient system of measurement.

20. A precise lazer tool according to claim 1 comprising a magnetic tape measure wherein a magnetic tip allows the tip to adhere to any ferrous surface.
